(19) United States
(12) Patent Application Publication
(10) Pub. No.: US 2023/0034264 A1
(43) Pub. Date: Feb. 2, 2023

(54) ELECTRIC VEHICLE CHARGING MODE RECOMMENDATION APPARATUS AND METHOD USING VEHICLE DRIVING DATA

(71) Applicants: Hyundai Motor Company, Seoul (KR); Kia Corporation, Seoul (KR)

(72) Inventor: Yeol Mae Yeo, Cheonan (KR)

(21) Appl. No.: 17/841,260

(22) Filed: Jun. 15, 2022

(30) Foreign Application Priority Data
Jul. 30, 2021 (KR) 10-2021-0100937

(51) Int. Cl. G07C 5/02; B60L 58/12; B60L 58/16

(52) U.S. Cl. CPC G07C 5/02; B60L 58/12; B60L 58/16

(57) ABSTRACT

An electric vehicle charging mode recommendation apparatus and method are provided. The electric vehicle charging mode recommendation apparatus includes a processor and a memory connected to the processor. The memory is configured to store a plurality of program instructions that, when executed by the processor, cause the processor to group first vehicle driving data collected from a plurality of vehicles according to a preset method and to assign a grade corresponding to a battery state for each group.

### CROSS REFERENCE TO RELATED APPLICATION

The application claims, under 35 U.S.C. § 119(a), the benefit of Korean Patent Application No. 10-2021-0100937, filed Jul. 30, 2021, the disclosure of which is incorporated herein by reference in its entirety.

### BACKGROUND

### Technical Field

Embodiments of the present disclosure relate to an electric vehicle charging mode recommendation apparatus and method and, more particularly, to an electric vehicle charging mode recommendation apparatus and method using vehicle driving data.

### Description of the Related Art

An electric vehicle is a vehicle that uses a battery engine operated by electric energy output from a battery. Since such an electric vehicle uses a battery capable of charging and discharging as a main power source, the electric vehicle provides an advantage of having no exhaust gas and very little noise.

The performance of an electric vehicle battery directly affects the performance of an electric vehicle. Batteries used in electric vehicles suffer from deterioration in performance due to continuous use. When the battery deteriorates, problems, such as a reduction in driving distance and a decrease in output upon acceleration of a vehicle, occur, even if the state of charge (SOC) is the same.

Since early replacement of batteries due to rapid deterioration can be a financial burden to users and, ultimately, the satisfaction for a vehicle can be sharply reduced at the manufacturer or manager level, there is a need to help users manage battery life for electric vehicles.

The foregoing is intended merely to aid in the understanding of the background of the present disclosure, and is not intended to mean that the embodiments of the present disclosure fall within the purview of the existing technologies that is already known to those skilled in the art.

### SUMMARY

Accordingly, an objective of the present disclosure is to provide an electric vehicle charging mode recommendation apparatus and method configured to recommend an electric vehicle battery charging mode suitable for a user's driving style.

In order to accomplish the above objective, according to an exemplary embodiment of the present disclosure, there is provided an electric vehicle charging mode recommendation apparatus including a processor and a memory connected to the processor. The memory is configured to store a plurality of program instructions that, when executed by the processor, cause the processor to group first vehicle driving data collected from a plurality of vehicles according to a preset method, into one or more groups, and to assign a grade corresponding to a battery state for each group in the one or more groups.

In an exemplary embodiment, each piece of the first vehicle driving data may include at least one of distance information, charging mode information, state of charge (SOC) information, and state of health (SOH) information of a battery of a corresponding vehicle.

In an exemplary embodiment, the program instructions are further configured to cause the processor to perform a first grouping of the first vehicle driving data into a first group of data using the distance information.

In an exemplary embodiment, the program instructions are further configured to cause the processor to perform a second grouping of the first vehicle driving data into a second group of data using the charging mode information.

In an exemplary embodiment, the program instructions are further configured to cause the processor to perform a third grouping of the first vehicle driving data into a third group of data using the SOH information, wherein the third grouping is processed for the second group.

In an exemplary embodiment, the program instructions are further configured to cause the processor to assign grades to respective third group elements using the SOH information.

In an exemplary embodiment, the program instructions are further configured to cause the processor to detect a user group using second vehicle driving data corresponding to a user vehicle, and generate recommended information using a group higher than the user group.

In an exemplary embodiment, the program instructions are further configured to cause the processor to detect the user group using one or more of charging mode information and SOC information included in the second vehicle driving data.

In an exemplary embodiment, the program instructions are further configured to cause the processor to generate the recommended information using one or more of charging mode information and state of charge (SOC) information included in the higher group.

In an exemplary embodiment, the program instructions are further configured to cause the processor to, when the higher group is provided with higher charging mode information identical to the charging mode information included in the second vehicle driving data, generate the recommended information using SOC information corresponding to the higher charging mode information.

In an exemplary embodiment, the program instructions are further configured to cause the processor to, when the higher group is provided with higher SOC information identical to the SOC information included in the second vehicle driving data, generate the recommended information using charging mode information corresponding to the higher SOC information.

According to another exemplary embodiment of the present disclosure, there is provided an electric vehicle charging mode recommendation apparatus including a processor and a memory connected to the processor. The memory is configured to store a plurality of program instructions that, when executed by the processor, cause the processor to detect a user group using second vehicle driving data corresponding to a user vehicle and to generate recommended information using a group higher than the user group among a plurality of groups for which grades are preset, wherein the plurality of grade-preset groups are grouped according to a preset method using first vehicle driving data collected from a plurality of vehicles, and are assigned grades according to state of health (SOH) of a battery for each group.

In an exemplary embodiment, each piece of the first vehicle driving data may include at least one of distance information, charging mode information, state of charge (SOC) information, and state of health (SOH) information of a battery of a corresponding vehicle.

In an exemplary embodiment, the program instructions are further configured to cause the processor to process the first vehicle driving data with first grouping into a first group of data using the distance information.

In an exemplary embodiment, the program instructions are further configured to cause the processor to process the first vehicle driving data with second grouping into a second group of data using the charging mode information.

In an exemplary embodiment, the program instructions are further configured to cause the processor to process the first vehicle driving data with third grouping into a third group of data using the SOC information, wherein the third grouping is processed for the second group.

In an exemplary embodiment, a grade of respective third group elements may be assigned using the SOH information.

In an exemplary embodiment, the program instructions are further configured to cause the processor to detect the user group using one or more of charging mode information and state of charge (SOC) information included in second vehicle driving data.

In an exemplary embodiment, the program instructions are further configured to cause the processor to generate the recommended information using one or more of charging mode information and state of charge (SOC) information included in the higher group.

In an exemplary embodiment, the program instructions are further configured to cause the processor to, when the higher group is provided with higher charging mode information identical to the charging mode information included in the second vehicle driving data, generate the recommended information using SOC information corresponding to the higher charging mode information.

In an exemplary embodiment, the program instructions are further configured to cause the processor to, when the higher group is provided with higher SOC information identical to the SOC information included in the second vehicle driving data, generate the recommended information using charging mode information corresponding to the higher SOC information.

According to the present disclosure, by using vehicle driving data collected from a plurality of vehicles, it is possible to recommend an electric vehicle battery charging mode corresponding to the user's driving style, thereby helping a user to manage the life of an electric vehicle.

In addition, according to the present disclosure, with the aid of the user's management of battery life of an electric vehicle, battery replacement cost can be reduced and user's satisfaction for an electric vehicle can be increased.

### BRIEF DESCRIPTION OF THE DRAWINGS

In order to more fully understand the drawings recited in the Detailed Description of the present disclosure, a brief description of drawings will be provided as follows:

FIG. 1 is a block diagram of an electric vehicle charging mode recommendation system according to an exemplary embodiment of the present disclosure;

FIG. 2 is a block diagram of an electric vehicle charging mode recommendation apparatus according to an exemplary embodiment of the present disclosure;

FIG. 3 is a flowchart of a method of generating a rating table for each group according to an exemplary embodiment of the present disclosure;

FIG. 4 is a diagram illustrating a configuration of vehicle driving data according to an exemplary embodiment of the present disclosure;

FIG. 5 is a diagram illustrating a rating table for each group according to an exemplary embodiment of the present disclosure;

FIG. 6 is a flowchart illustrating an electric vehicle charging mode recommendation method according to an exemplary embodiment of the present disclosure; and

FIG. 7 is a diagram illustrating a case in which an electric vehicle charging mode is recommended according to an exemplary embodiment of the present disclosure.

### DETAILED DESCRIPTION

Exemplary embodiments according to the technical spirit of the present disclosure are provided to more completely explain the technical spirit of the present disclosure to those of ordinary skill in the art, and the following embodiments may be modified in various other forms, so the range of the technical spirit of the present disclosure is not limited to the following embodiments. Rather, these embodiments are provided so as to more fully complete the present disclosure, and to fully convey the technical spirit of the present disclosure to those skilled in the art.

It will be understood that although the terms “first”, “second”, etc. may be used herein to describe various members, regions, layers, parts and/or elements, these members, regions, layers, parts and/or elements should not be limited by these terms. These terms do not mean specific order, superiority, or dominance, but are only used to distinguish one member, region, part, or element from other members, regions, parts, or elements. Thus, a first member, region, part, or element discussed below could be termed a second member, region, part, or element and vice versa without departing from the nature of the present disclosure. For example, without departing from the scope of the present disclosure, a first element may be referred to as a second element, and similarly, a second element may also be referred to as a first element.

Unless otherwise defined, the meaning of all terms including technical and scientific terms used herein is the same as that commonly understood by one of ordinary skill in the art to which the present disclosure pertains. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

As used herein, the term ‘and/or’ includes each of and every combination of one or more of the recited elements.

Hereinafter, embodiments according to the technical spirit of the present disclosure will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

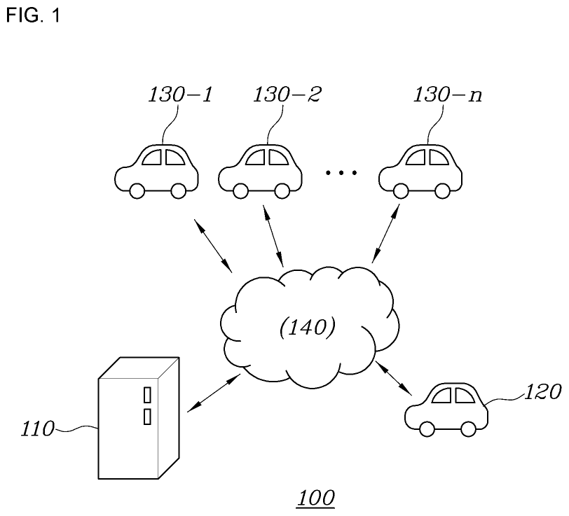

FIG. 1 is a block diagram of an electric vehicle charging mode recommendation system according to an embodiment of the present disclosure.

Referring to FIG. 1, the electric vehicle charging mode recommendation system 100 according to an exemplary embodiment of the present disclosure includes an electric vehicle charging mode recommendation apparatus 110, a user vehicle 120, and a plurality of other vehicles 130-1 to 130-n (n is a natural number equal to or greater than 2). The electric vehicle charging mode recommendation apparatus 110, the user vehicle 120, and other vehicles 130-1 to 130-n may be electrically connected to each other through a network 140. Here, the network 140 may be any kind of communication network, such as the Internet, a mobile network, and a local area wireless network (e.g., Bluetooth), so long as it can connect the electric vehicle charging mode recommendation apparatus 110, the user vehicle 120, and other vehicles 130-1 to 130-n by wire and/or wirelessly.

Some or all of the user vehicle 120 and the plurality of other vehicles 130-1 to 130-n may be electric vehicles, which include batteries. The user vehicle 120 and the plurality of other vehicles 130-1 to 130-n may include a battery management system (BMS), a system for analyzing driving information of the corresponding vehicle through vehicle electronic control unit (ECU) information, etc. Accordingly, the user vehicle 120 and the plurality of other vehicles 130-1 to 130-n may be configured to generate vehicle driving data and transmit the same to the electric vehicle charging mode recommendation apparatus 110 according to a preset method. A specific configuration of the vehicle driving data will be described later.

The electric vehicle charging mode recommendation apparatus 110 may be configured to analyze one or more pieces of vehicle driving data (hereinafter, referred to as ‘first vehicle driving data’) received from the plurality of other vehicles 130-1 to 130-n to group the same according to a vehicle driving pattern or style, and to assign grades to the respective one or more groups according to a preset method.

In addition, the electric vehicle charging mode recommendation apparatus 110 may be configured to analyze one or more pieces of vehicle driving data (hereinafter referred to as “second vehicle driving data”) received from the user vehicle 120 to recommend a charging mode capable of delaying battery deterioration of the user vehicle 120.

Hereinafter, the grading operation and the charging mode recommendation operation of the electric vehicle charging mode recommendation apparatus 110 will be described in detail.

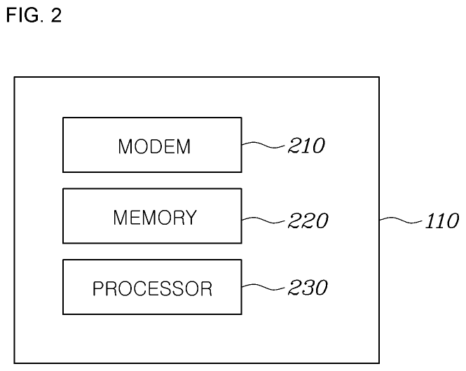

FIG. 2 is a block diagram illustrating an electric vehicle charging mode recommendation apparatus 110 according to an exemplary embodiment of the present disclosure.

The electric vehicle charging mode recommendation apparatus 110 may include a modem (MODEM) 210, a memory (MEMORY) 220, and a processor (PROCESSOR) 230.

The modem 210 may be configured to connect to the network 140 to allow the electric vehicle charging mode recommendation apparatus 110 to transmit and/or receive signals to and/or from one or more other devices. In particular, the modem 210 may be configured to receive first vehicle driving data and/or second vehicle driving data from the plurality of other vehicles 130-1 to 130-n or the user vehicle 120.

The memory 220 may be configured to store first vehicle driving data, second vehicle driving data, and program commands for the operation of the electric vehicle charging mode recommendation apparatus 110, and may be a memory device such as a hard disk, a solid state drive, etc. In particular, the memory 220 may be configured to store program instructions that, when executed by the processor 230, cause the processor 230 to group the first vehicle driving data according to a preset method and assign grades to respective groups. In addition, the memory 220 may be configured to store program instructions that, when executed by the processor 230, cause the processor 230 to recommend a charging mode capable of delaying the deterioration of a battery of the user's vehicle 120 by analyzing the second vehicle driving data and the graded groups.

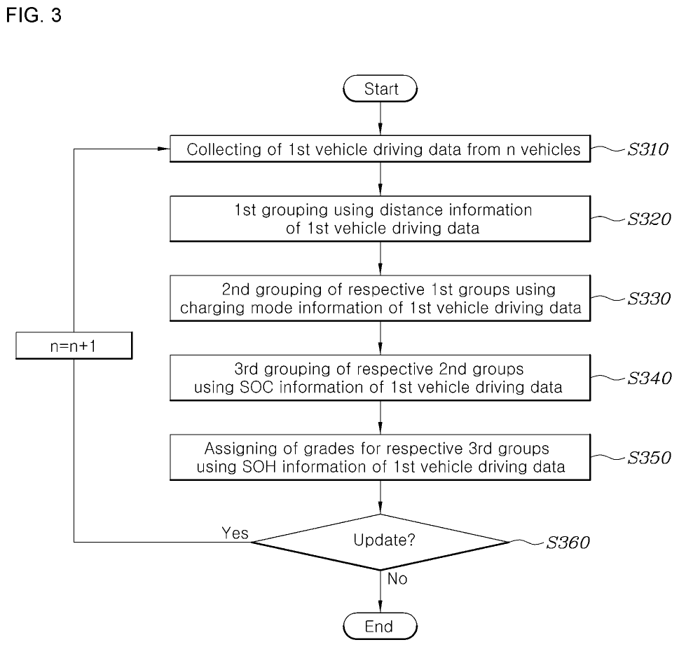

The processor 230 may be configured to execute the first vehicle driving data, the second vehicle driving data, and other program instructions stored in the memory 220. Hereinafter, the functions of the program instructions executed by the processor 230 will be described in detail with reference to FIGS. 3 to 7.

FIG. 3 is a flowchart illustrating a method of generating a group-specific rating table according to an exemplary embodiment of the present disclosure.

Respective steps to be described with reference to FIG. 3 may be concerned with functions of program instructions executed by the processor 230, wherein the program instructions may be stored in the memory 220. However, for convenience of understanding and explanation, the description will be made so that the operations of the respective steps are performed by the processor 230.

In step S310, the processor 230 may be configured to store the first vehicle driving data, received by the modem 210 from the plurality of other vehicles 130-1 to 130-n, in the memory 220.

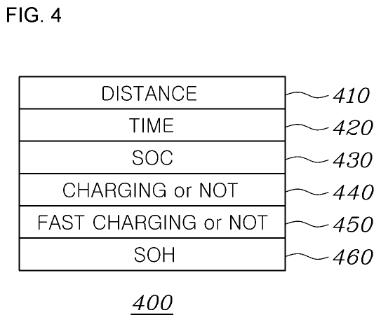

The first vehicle driving data may be information that is concerned with batteries and/or driving of the plurality of other vehicles 130-1 to 130-n, and may be received from the respective other vehicles 1301-1 to 130-n upon the occurrence of a predetermined event. According to an exemplary embodiment, the information included in the first vehicle driving data is illustrated in FIG. 4.

FIG. 4 is a diagram illustrating a configuration of vehicle driving data according to an exemplary embodiment of the present disclosure.

The information illustrated in FIG. 4 may be information that is included in both the first vehicle driving data and the second vehicle driving data. That is, the vehicle driving data 400 may, e.g., include the following information:

(1) Distance information 410: Information about the total driving distance of a vehicle;

(2) Time information 420: Information about the time at which the vehicle driving data is transmitted;

(3) State of charge (SOC) information 430: Information about remaining battery level during transmission of vehicle driving data;

(4) Charging information 440: Information about whether a battery is charging or not during transmission of vehicle driving data;

(5) Charging mode information 450: Information about whether a battery is charging in high-speed charging mode or low-speed charging mode during transmission of driving data of corresponding vehicle; and

(6) State of health (SOH) information 460 of battery: Information about battery life during transmission of vehicle driving data.

The vehicle driving data 400 may be generated when a preset event occurs. Although an exemplary preset event may be as follows, a description will be made of the case where the vehicle driving data 400 is generated upon battery charging start and end events.
Reaching preset time interval
Battery charging start and/or end
Vehicle driving start and/or end
Preset time lapse after vehicle driving start
Vehicle stop during vehicle driving

On the other hand, vehicle driving data may be statistically managed for each vehicle. That is, a plurality of pieces of 1-1^{st} vehicle driving data received from a first vehicle may be statistically processed and managed as a single file.

For example, the distance information 410 of the first vehicle driving data of the first vehicle may be updated with the latest distance information received.

As another example, the SOC information 430 of the first vehicle driving data of the first vehicle may be managed as a battery level average value at the charging start point to the charging end point of the first vehicle. That is, when the average value at the charging start point of the first vehicle is 20, and the average value of the charging end point is 90, the SOC information of the first vehicle driving data of the first vehicle may be managed in a state of being updated with “20 to 90”.

As a further example, the charging mode information 450 of the first vehicle driving data of the first vehicle may be managed in a rate of high-speed charging and the low-speed charging. In other words, when the first vehicle is charged such that the low-speed charging is performed once whenever high-speed charging is performed nine times in average, the charging mode information of the first vehicle driving data of the first vehicle may be managed in a state of being updated with “9:1”.

Referring back to FIG. 3, in step S320, the processor 230 may be configured to perform a first grouping process of the first vehicle driving data using the distance information 410 of the first vehicle driving data. For example, the processor 230 may be configured to perform the first grouping process that divides the most recently updated pieces of first vehicle driving data into a 1-1^{st} group of first vehicle driving data, having distance data ranging from 1 km to 100,000 km, and a 1-2^{nd} group of first vehicle driving data, having distance data with the other range (i.e., distance information of the first vehicle driving data ranging 100,000 km or more). Here, 100,000 km is an exemplary number, so it is apparent that the number cannot limit the scope of the present disclosure.

In step S330, the processor 230 may be configured to perform a second grouping process of the first vehicle driving data using the charging mode information 450 of the respective first groups of the first vehicle driving data. For example, the processor 230 may be configured to process the second grouping process that divides the most recently updated pieces of first vehicle driving data into a second group of first vehicle driving data having the same charging mode information 450.

At this time, the second grouping process may be processed for the first group. That is, it may be assumed that the first group is divided into two groups (1-1^{st} and 1-2^{nd} groups) by the first grouping process. In this case, the processor 230 may be configured to divide the 1-1^{st} group of first vehicle driving data into a data group having the same charging mode information 450, and may be configured to divide the 1-2^{nd} group of first vehicle driving data into a data group having the same charging mode information 450.

In step S340, the processor 230 may be configured to perform a third grouping process of the first vehicle driving data using the SOC information 430 of the second group of first vehicle driving data. For example, the processor 230 may be configured to perform the third grouping process that divides the most recently updated pieces of first vehicle driving data into a third group of first driving data having the same SOC information 430 or the SOC information that is accepted to be substantially the same.

Here, one of examples of the SOC information that may be accepted to be substantially the same may be the case in which, although the average battery level at the charging start point and/or the average battery level at the charging end point has the same value, the number below the decimal points is different. Alternatively, another example of the SOC information that is accepted to be substantially the same may be the case in which the average battery level at the charging start point and/or the average battery level at the charging end point, which may be rounded off to one decimal point, has the same value.

Also, the third grouping process may be processed for the second group. That is, it may be assumed that the first group is divided into two groups (1-1-1^{st} and 1-1-2^{nd} groups) by the second grouping process. In this case, the processor 230 may be configured to divide the 1-1-1^{st} group of first vehicle driving data into a data group having the same SOC information 430, and may be configured to divide the 1-1-2^{nd} group of first vehicle driving data into a data group having the same charging mode information 450.

In step S350, the processor 230 may be configured to use the SOH information 460 of the first vehicle driving data to assign grades for third group. If there is no significant difference in the driving environment of the vehicles 130-1 to 130-n, the SOH information 460 of the same third group may be equal or similar. This is because the same third group may be information of vehicles that travel a similar distance and have similar charging modes and states.

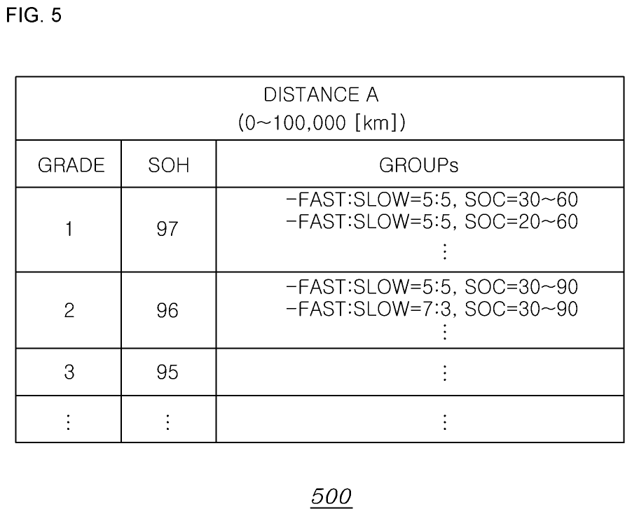

For example, the processor 230 may be configured to assign a first grade to the third groups having the highest SOH information 460, assign a second grade to the third groups having the secondarily highest SOH information 460, and assign a third grade to the third groups having the thirdly highest SOH information 460. That is, higher grades corresponding to the higher order of the SOH information 460 may be assigned to the third groups. FIG. 5 illustrates the case in which the third groups divided by grade are shown in a table.

FIG. 5 is a diagram illustrating a rating table 500 for groups according to an exemplary embodiment of the present disclosure.

Referring to FIG. 5, the SOH information 460 of the third group corresponding to the first grade is ‘97’, and the SOH information 460 of the third group corresponding to the second grade is ‘96’.

Referring also to FIG. 5, the charging mode information 450 and the SOC information 430 of the third group corresponding to the first grade may be as follows:
Charging mode information (FAST:SLOW)=5:5, SOC information 430=30 to 60;
Charging mode information (FAST:SLOW)=5:5, SOC information 430=20 to 60.

Referring also to FIG. 5, the charging mode information 450 and the SOC information 430 of the third group corresponding to the second grade may be as follows:
Charging mode information (FAST:SLOW)=5:5, SOC information 430=30 to 90;
Charging mode information (FAST:SLOW)=7:3, SOC information 430=30 to 90.

Referring back to FIG. 3, in step S360, when first vehicle driving data of a new vehicle or new first vehicle driving data of the previous vehicle is received, the processor 230 may be configured to update corresponding first vehicle driving data using the received data.

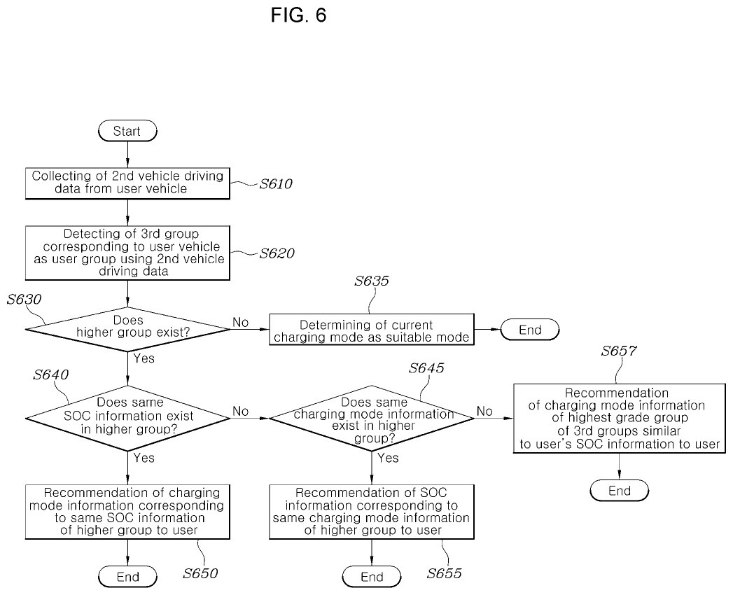

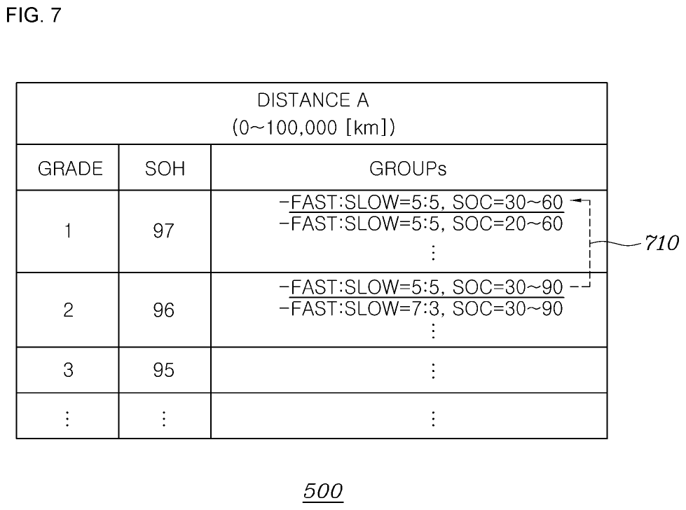

Thereafter, the processor 230 may be configured to recommend a charging mode capable of delaying the deterioration of the battery of the user vehicle 120 by analyzing the second vehicle driving data received from the user vehicle 120 and the rated third groups. This will be described in detail with reference to FIGS. 6 and 7.

FIG. 6 is a flowchart illustrating a method of recommending an electric vehicle charging mode according to an exemplary embodiment of the present disclosure.

Respective steps to be described below with reference to FIG. 6 are concerned with functions of program instructions executed by the processor 230, wherein the program instructions may be stored in the memory 220. However, for convenience of understanding and explanation, the description will be made so that the operations of the respective steps are performed by the processor 230.

In step S610, the processor 230 may be configured to store second vehicle driving data, received from a user vehicle 120, in the memory 220. The second vehicle driving data may be generated and received whenever a preset event occurs. Also, the processor 230 may be configured to statistically manage the second vehicle driving data as for the first vehicle driving data. Therefore, whenever the second vehicle driving data is received, the processor 230 may be configured to update the same by reflecting the latest information according to a preset method. For example, the processor 230 may be configured to reflect and store the latest second vehicle driving data with respect to distance information 410, SOC information 430, charging mode information 450, SOH information 460, and the like of the second vehicle driving data. An operation of the processor 230 to update the second vehicle driving data may be substantially the same as the operation for updating the first vehicle driving data.

In step S620, the processor 230 may be configured to detect a third group corresponding to the user vehicle 120 using the second vehicle driving data. Hereinafter, the detected third group is referred to as a “user group,” to be distinguished from other third groups. For example, the processor 230 may be configured to detect, as a user group, the third group including the charging mode information 450 and/or SOC information 430 that is the same as, or is accepted to be substantially the same as, the latest updated second vehicle driving data.

In step S630, the processor 230 may be configured to determine whether a third group having a higher grade than the user group exists or not. As a result of the determination in step S630, if it is determined that there is no third group having a higher grade than the user group, the processor 230 may be configured to determine that the current charging mode of the user vehicle 120 is suitable (step S635).

On the other hand, as a result of the determination in step S630, if it is determined that there is a third group having a higher grade than the user group, the processor 230 may be configured to determine whether the higher grade group is provided with the SOC information 430 that is the same as or is accepted to be substantially the same as the latest updated second vehicle driving data or not (step S640). For example, the processor 230 may be configured to determine whether the third group having a grade immediately above the user grade (i.e., the grade of the user group) is provided with the SOC information 430 that is the same as, or is accepted to be substantially the same as, the latest updated second vehicle driving data or not.

As a result of the determination in step S640, if it is determined that the higher group is provided with the SOC information 430 that is the same as or is accepted to be substantially the same as the latest updated second vehicle driving data, the processor 230 may be configured to generate recommended information for the user vehicle 120 using charging mode information 450 corresponding to the same SOC information 430 of the higher group (step S650). This is because the corresponding vehicle may maintain a better battery state through a different charging mode than the user vehicle 120. Accordingly, the corresponding recommended information may include a charging mode (a rate of rapid charging and slow charging) corresponding to the higher third group.

On the other hand, as a result of the determination in step S640, if it is determined that there is no SOC information 430 that is the same as or is accepted to be substantially the same as the latest updated second vehicle driving data in the higher group, the processor 230 may be configured to determine whether the higher grade group is provided with the charging mode information 450 that is the same as or is accepted to be substantially the same as the latest updated second vehicle driving data or not (step S645).

As a result of the determination in step S645, if it is determined that the higher group is provided with the charging mode information 450 that is the same as, or is accepted to be substantially the same as, the latest updated second vehicle driving data, the processor 230 may be configured to generate recommended information for the user vehicle 120 using SOC information 430 corresponding to the same charging mode information 450 of the higher group (step S655). This is because the corresponding vehicle may maintain a better battery state through different SOC than the user vehicle 120. Accordingly, the corresponding recommended information may include state of charge (at charging start and/or end) corresponding to the higher third group.

As a result of the determination in step S645, if it is determined that the higher group is not provided with the charging mode information 450 that is the same as or is accepted to be substantially the same as the latest updated second vehicle driving data, the processor 230 may be configured to generate recommended information for the user vehicle 120 using charging mode information of the highest grade third group that is similar to the SOC information of the user vehicle (step S657). This is because the corresponding vehicle may maintain a better battery state through a similar state of charge to the user vehicle 120. Accordingly, the corresponding recommended information may include a charging mode (a rate of rapid charging and slow charging) corresponding to the higher third group.

FIG. 7 is a diagram illustrating a case in which an electric vehicle charging method is recommended according to an exemplary embodiment of the present disclosure.

Referring to FIG. 7, a case is illustrated in which the user grade corresponds to a second grade, and a third group corresponding to a first grade includes the same charging mode information as the second vehicle driving data. Accordingly, the processor 230 may be configured to generate the recommended information using SOC information of “30 to 60” of the third group in which the charging mode information is “5:5” (710).

Thereafter, the processor 230 may be configured to transmit the recommended information to the user vehicle 120.

The user vehicle 120 may be configured to display the received recommended information to allow the user to visually and/or audibly recognize the recommended information for delaying battery degradation. In the case of the example of FIG. 7, the contents of the recommended information may be as follows:

“Currently, you start charging when the battery level reaches 30% and stop charging when the battery level reaches 90%. To extend the life of the battery, it is recommended to start charging when the battery level reaches 30% and stop charging when the battery level reaches 60%”

In addition, the user vehicle 120 may be configured to induce the user to start charging by outputting the remaining battery level when reaching the recommended information, and may be configured to induce the user to stop charging when the remaining battery level corresponds to the recommended information during charging.

As mentioned above, although the present disclosure has been described and illustrated with respect to the specific embodiments, it would be obvious to those skilled in the art that various improvements and/or modifications are possible, without departing from the scope and spirit of the present disclosure as disclosed in the accompanying claims.

What is claimed is:

1. An electric vehicle charging mode recommendation apparatus comprising:
a processor; and
a memory connected to the processor, configured to store a plurality of program instructions that, when executed by the processor, cause the processor to:
group first vehicle driving data, collected from a plurality of vehicles, according to a preset method, into one or more groups; and
assign a grade corresponding to a battery state for each group in the one or more groups.

2. The electric vehicle charging mode recommendation apparatus according to claim 1, wherein:
the first vehicle driving data includes one or more pieces, and
each of the one or more pieces of the first vehicle driving data includes at least one of:
distance information of a corresponding vehicle;
charging mode information of the corresponding vehicle;
state of charge (SOC) information of the corresponding vehicle; and
state of health (SOH) information of a battery of the corresponding vehicle.

3. The electric vehicle charging mode recommendation apparatus according to claim 2, wherein the program instructions are further configured to cause the processor to:
perform a first grouping of the first vehicle driving data into a first group of data using the distance information.

4. The electric vehicle charging mode recommendation apparatus according to claim 2, wherein the program instructions are further configured to cause the processor to:
perform a second grouping of the first vehicle driving data into a second group of data using the charging mode information.

5. The electric vehicle charging mode recommendation apparatus according to claim 4, wherein the program instructions are further configured to cause the processor to:
perform a third grouping of the first vehicle driving data into a third group of data using the SOH information, wherein the third grouping is processed for the second group.

6. The electric vehicle charging mode recommendation apparatus according to claim 5, wherein the program instructions are further configured to cause the processor to:
assign grades to respective third group elements using the SOH information.

7. The electric vehicle charging mode recommendation apparatus according to claim 1, wherein the program instructions are further configured to cause the processor to:
detect a user group using second vehicle driving data corresponding to a user vehicle; and
generate recommended information using a higher group, wherein the higher group is a group higher than the user group.

8. The electric vehicle charging mode recommendation apparatus according to claim 7, wherein the program instructions are further configured to cause the processor to:
detect the user group using one or more of:
charging mode information included in the second vehicle driving data; and
SOC information included in the second vehicle driving data.

9. The electric vehicle charging mode recommendation apparatus according to claim 7, wherein the program instructions are further configured to cause the processor to:
generate the recommended information using one or more of:
charging mode information included in the higher group; and
state of charge (SOC) information included in the higher group.

10. The electric vehicle charging mode recommendation apparatus according to claim 9, wherein the program instructions are further configured to cause the processor to, when the higher group is provided with higher charging mode information identical to the charging mode information included in the second vehicle driving data:
generate the recommended information using SOC information corresponding to the higher charging mode information.

11. The electric vehicle charging mode recommendation apparatus according to claim 9, wherein the program instructions are further configured to cause the processor to, when the higher group is provided with higher SOC information identical to the SOC information included in the second vehicle driving data:
generate the recommended information using charging mode information corresponding to the higher SOC information.

12. An electric vehicle charging mode recommendation apparatus comprising:
a processor; and
a memory connected to the processor, configured to store a plurality of program instructions that, when executed by the processor, cause the processor to:
detect a user group using second vehicle driving data corresponding to a user vehicle; and
generate recommended information using a higher group, wherein the higher group is a group higher than a user group among a plurality of groups for which grades are preset,
wherein a plurality of grade-preset groups are grouped according to a preset method using first vehicle driving data collected from a plurality of vehicles, and are assigned grades according to state of health (SOH) of a battery for each group of the plurality of grade-preset groups.

13. The electric vehicle charging mode recommendation apparatus according to claim 12, wherein:
the first vehicle driving data includes one or more pieces, and
each of the one or more pieces of the first vehicle driving data includes at least one of:
distance information of a corresponding vehicle;
charging mode information of the corresponding vehicle;
state of charge (SOC) information of the corresponding vehicle; and
state of health (SOH) information of a battery of the corresponding vehicle.

14. The electric vehicle charging mode recommendation apparatus according to claim 13, wherein the program instructions are further configured to cause the processor to:
process first vehicle driving data with first grouping into a first group of data using the distance information.

15. The electric vehicle charging mode recommendation apparatus according to claim 14, wherein the program instructions are further configured to cause the processor to:
process the first vehicle driving data with second grouping into a second group of data using the charging mode information.

16. The electric vehicle charging mode recommendation apparatus according to claim 15, wherein the program instructions are further configured to cause the processor to:
process the first vehicle driving data with third grouping into a third group of data using the SOC information, wherein the third grouping is processed for the second group.

17. The electric vehicle charging mode recommendation apparatus according to claim 16, wherein the program instructions are further configured to cause the processor to:
assign a grade of respective third group elements using the SOH information.

18. The electric vehicle charging mode recommendation apparatus according to claim 12, wherein the program instructions are further configured to cause the processor to:
detect the user group using one or more of:
charging mode information included in the second vehicle driving data; and
state of charge (SOC) information included in the second vehicle driving data.

19. The electric vehicle charging mode recommendation apparatus according to claim 12, wherein the program instructions are further configured to cause the processor to:
generate the recommended information using one or more of:
charging mode information included in the higher group; and
state of charge (SOC) information included in the higher group.

20. The electric vehicle charging mode recommendation apparatus according to claim 19, wherein the program instructions are further configured to cause the processor to, when the higher group is provided with higher charging mode information identical to the charging mode information included in the second vehicle driving data:
generate the recommended information using SOC information corresponding to the higher charging mode information.
